(19) United States
(12) Patent Application Publication
(10) Pub. No.: US 2012/0161404 A1
(43) Pub. Date: Jun. 28, 2012

(54) WORKHOLDING APPARATUS FOR MACHINE TOOL

(75) Inventors: Craig R. Ronald, Fairport, NY (US); Donald L. Allis, Churchville, NY (US); Kenneth E. Glasow, Spencerport, NY (US)

(73) Assignee: THE GLEASON WORKS, Rochester, NY (US)

(21) Appl. No.: 13/386,115

(22) PCT Filed: Sep. 14, 2010
(86) PCT No.: PCT/US2010/048723

§ 371 Date: Jan. 20, 2012

Related U.S. Application Data
(60) Provisional application No. 61/243,206, filed on Sep. 17, 2009.

(51) Int. Cl. B23Q 3/12; B23B 31/36

(52) U.S. Cl. 279/9.1; 29/525.03

(57) ABSTRACT

The present invention is directed to an arbor chuck workholding assembly comprising an arbor chuck (2), outer ring (6), clamp ring (8) and backing ring (10). The arbor chuck comprises a plurality of holding angle lugs (18) and ejecting angle lugs (20) located about its periphery. The outer ring (6) comprises a plurality of complementary holding angle ramps (22) and ejecting angle ramps (24) located on its inner diameter surface. A machine spindle (4) is rotated to engage the holding angled lugs (18) with the holding angle ramps (22) such that the arbor chuck will be drawn into position against the spindle. For disengaging, a reverse rotation of the spindle will result in ejecting angle ramps (24) engaging ejecting angle lugs(20) to loosen the arbor chuck from the spindle. Therefore, no tools are required to secure the arbor chuck to the machine spindle.

### FIELD OF THE INVENTION

The present invention is directed to a workholding apparatus for machine tools. In particular, the workholding apparatus is configured such that it is urged into an operating position on a machine spindle or loosened from the operating position on the spindle by rotation of the spindle.

### BACKGROUND OF THE INVENTION

In metalworking operations where a workpiece is machined, equipment of some type is necessary to hold the workpiece in position in a machine tool so the machining process can be successfully carried out. This type of equipment is known as “workholding” equipment. In the production of toothed articles, such as gears, workholding equipment may be generally categorized as arbor chucks. Examples of arbor chucks for gripping pinion shanks can be found in U.S. Pat. Nos. 3,083,976 to Stark and 3,244,427 to Taschl. An example of an arbor chuck for a ring gear can be found in U.S. Pat. No. 3,735,994 to Jaehn. An arbor chuck for expanding into contact with the bore of a pinion can be found in U.S. Pat. No. 3,517,939 to Jaehn.

Securing workholding equipment to a machine tool spindle, or ejecting it from the machine tool spindle, have traditionally been manually performed operations that are very time consuming since there are usually many bolts that must be tightened to specifications. When removing an arbor chuck, aside from the time necessary to loosen and remove all of the bolts, ejector screws usually must be utilized to “break” the contact between the arbor chuck outer tapered surface and the tapered inner surface of the spindle bore.

Workholding equipment may also be secured to a machine spindle via an interface attached to the spindle. The interface comprises a plurality of lugs arranged thereon. A workholding module having a spirally arranged groove on an inner surface is positioned over the interface to engage the lugs. The interface is then manually turned via a removable handle to “draw down” the module via the cooperating threading-like action of the lugs and spiral groove. The module is loosened from the interface by inserting the handle and turning the interface in the opposite direction.

Additionally, workholding equipment may be secured to a machine spindle via action of the machine draw rod as is shown in U.S. Pat. No. 6,260,855 to Curtis. The motion of the draw rod occurs in two segments with one rearward motion utilized to secure the workholding equipment on the tapered inner surface of the spindle bore and a further rearward motion utilized to activate the workholding equipment to secure a workpiece in position for machining. The workpiece is released from the workholding equipment by a first forward motion of the draw rod and an additional forward motion of the draw rod is utilized to loosen the workholding equipment from the tapered inner surface of the spindle bore.

### SUMMARY OF THE INVENTION

The present invention is directed to an arbor chuck workholding assembly comprising an arbor chuck, outer ring, clamp ring and backing ring. The arbor chuck comprises a plurality of holding angle lugs and ejecting angle lugs located about its periphery. The outer ring comprises a plurality of complementary holding angle ramps and ejecting angle ramps located on its inner diameter surface. The arbor chuck is inserted into a machine spindle which is then rotated to engage the holding angled lugs with the holding angle ramps such that the arbor chuck will be drawn into position against the spindle. For disengaging, a reverse rotation of the spindle results in ejecting angle ramps engaging ejecting angle lugs to loosen the arbor chuck from the spindle. Therefore, with the present invention, no tools are required to secure the arbor chuck to the machine spindle.

### BRIEF DESCRIPTION OF THE DRAWINGS

FIG. 1 is an exploded view showing the components of the inventive arbor chuck assembly.

FIG. 2 is a cross-sectional view of a partially assembled arbor chuck.

FIG. 3 is an enlarged view showing the angled lugs and ramps of the arbor chuck and outer ring.

FIG. 4 is a cross-sectional view of the inventive arbor chuck assembly positioned on a machine spindle.

### DETAILED DESCRIPTION OF THE PREFERRED EMBODIMENT

Before any features and at least one construction of the invention are explained in detail, it is to be understood that the invention is not limited in its application to the details of construction and the arrangements of the components set forth in the following description or illustrated in the drawings. The invention is capable of other constructions and of being practiced or being carried out in various ways. Also, it is understood that the phraseology and terminology used herein is for the purposes of description and should not be regarded as limiting.

The use of “including”, “having” and “comprising” and variations thereof herein is meant to encompass the items listed thereafter and equivalents thereof as well as additional items. Although references may be made below to directions such as upper, lower, upward, downward, rearward, bottom, top, front, rear, etc., in describing the drawings, the references are made relative to the drawings (as normally viewed) for convenience.

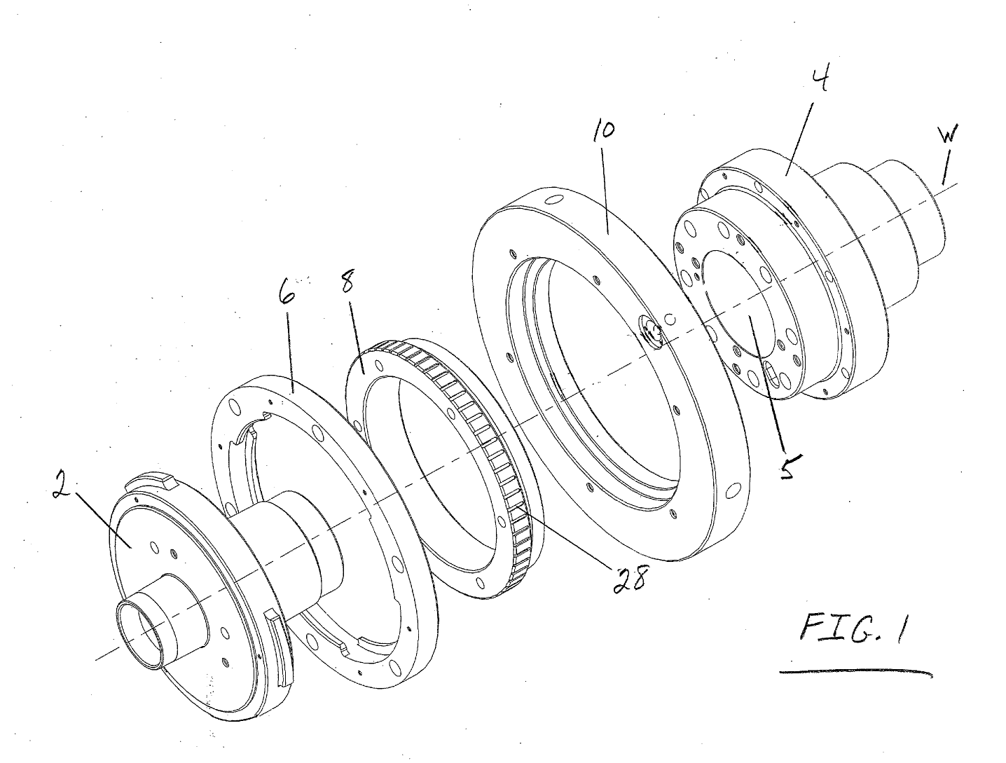

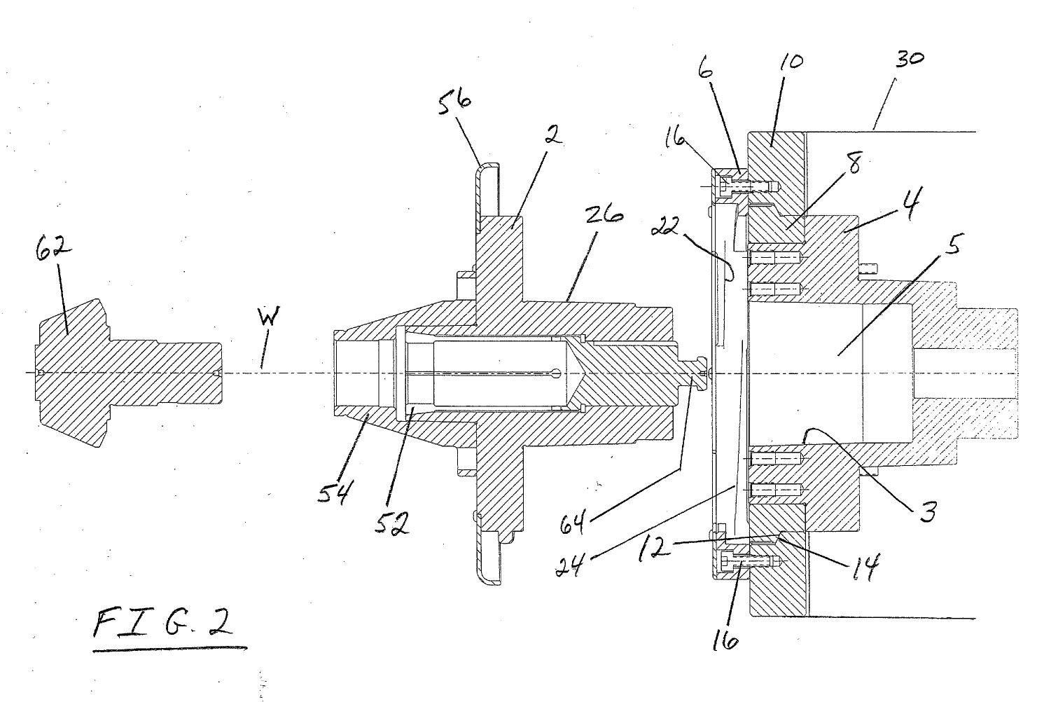

FIG. 1 illustrates the elements of a workholding assembly via which an arbor chuck 2 is attachable to and removable from a bore 5 of a spindle 4 (rotatable about work axis W) of a machine tool such as a gear manufacturing machine, for example, a CNC machine such as that shown in U.S. Pat. No. 6,712,566 the disclosure of which is hereby incorporated by reference. The workholding assembly includes an outer ring 6, clamp ring 8 and backing ring 10. Clamp ring 8 may include a plurality of spaced apart grooves 28 located about its outermost periphery which will be discussed further below. When assembled (FIG. 2), clamp ring 8 is positioned within backing ring 10 such that shoulder 12 of clamp ring 8 abuts against complementary shoulder 14 of backing ring 10. Clamp ring 8 is secured to spindle 4 such as by a plurality of screws (not shown) thereby positioning backing ring 10 on spindle 4. Outer ring 6 is secured to backing ring 10 such as by a plurality of screws 16 (two of which are shown). Given this arrangement, it can be seen that backing ring 10 together with outer ring 6 are rotatable with respect to spindle 4 and clamp ring 8.

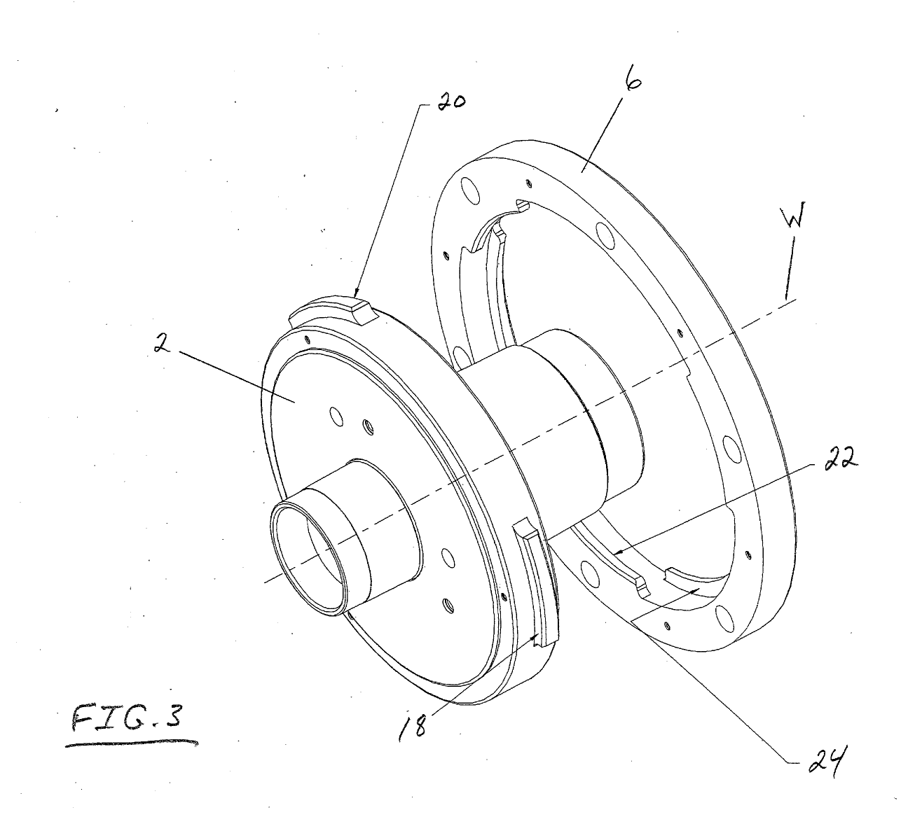

FIG. 3 shows the attachment features of the arbor chuck 2 and the outer ring 6. Arbor chuck 2 comprises a plurality of angled lugs, holding angle lug 18 and ejecting angle lug 20, located about its periphery. Outer ring 6 comprises a plurality of complementary angled ramps, holding angle ramp 22 and ejecting angle ramp 24 located on its inner diameter surface. Preferably, there are at least two of each angled lugs 18 and 20 and at least two of each angled ramps 22 and 24. Most preferably, there are three of each angled lugs 18 and 20 and three of each angled ramps 22 and 24.

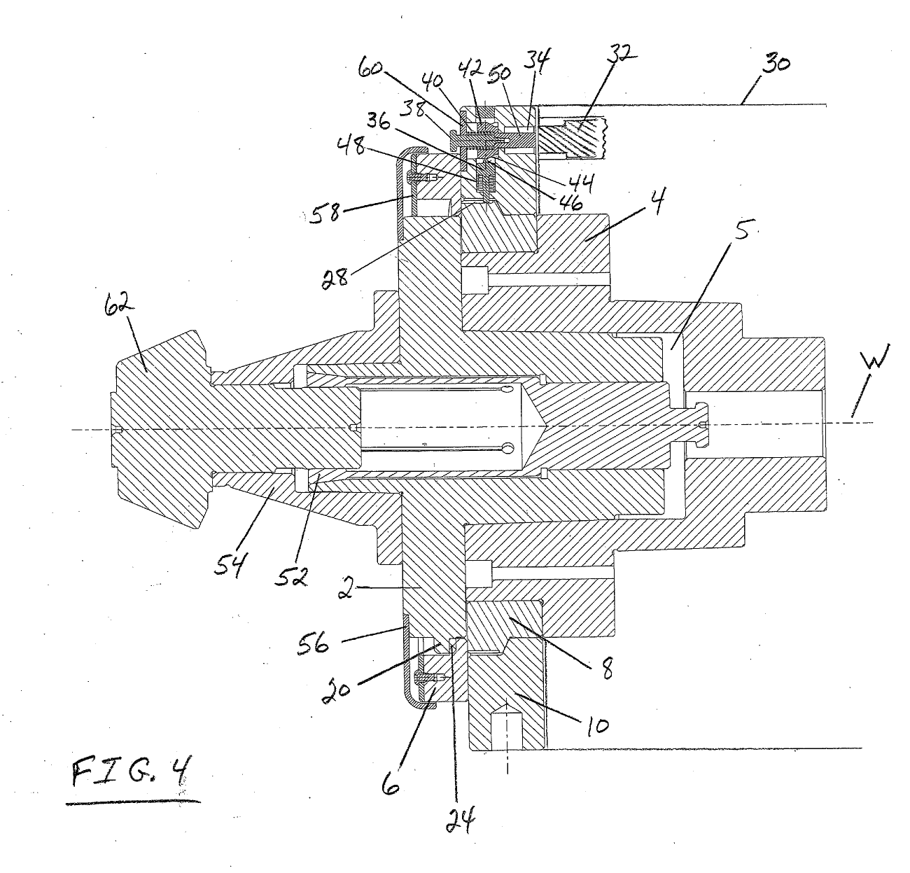

Holding angle lug 18 is oriented on the periphery of arbor chuck 2 in a manner such that when arbor chuck 2 is inserted into outer ring 6 and rotated a predetermined amount for holding by spindle 4 (for example, 90 degrees rotation in a clockwise direction or to a predetermined amount of torque), holding angled lug 18 will engage holding angle ramp 22 and arbor chuck 2 will be drawn into position against the spindle 4 (FIG. 4). For disengaging, a reverse rotation of the spindle 4 will result in ejecting angle ramp 24 engaging ejecting angle lug 20 to loosen the arbor chuck 2 from the spindle 4. That is, the tapered shank 26 of the arbor chuck 2 will be loosened from its position against the surface 3 of the tapered bore 5 of machine spindle 4. The arbor chuck 2 may then be removed from the machine.

Although backing ring 10 together with outer ring 6 are rotatable with respect to spindle 4 and clamp ring 8, securing the arbor chuck 2 in spindle 4 and ejecting arbor chuck 2 from spindle 4 is accomplished with the backing ring 10 and outer ring 6 held stationary during rotation of the spindle 4 as will be discussed further below. A preferred mechanism for holding backing ring 10 and outer ring 6 stationary is shown in FIG. 4 where a plunger 32 is shown positioned in spindle housing 30 although plunger 32 could be located in or on any element or structure separate from the clamp ring 8 or spindle 4. The plunger 32 may be advanced into and withdrawn from receiving bore 34 (of which one or more are located in backing ring 10) via any suitable manner such as hydraulically, pneumatically, electrically or manually. When advanced into receiving bore 34, backing ring 10 and outer ring 6 are locked against rotation thereby allowing spindle 4 to rotate in order to secure arbor chuck 2 in outer ring 6 or eject arbor chuck 2 from outer ring 6.

Additionally, it may be desirable to include means to safeguard against rotation of backing ring 10 and outer ring 6 relative to spindle 4 during machining operations. FIG. 4 shows a plunger 36 which can be advanced to engage one of the grooves 28 in clamp ring 8 thereby locking backing ring 10 and outer ring 6 to clamp ring 8 and spindle 4. With such locking, additional rotational movement (in either direction) of the outer ring 6 is prevented thereby ensuring against over-tightening or loosening of the arbor chuck 2 in the outer ring 6 due rotation of the spindle, or to the reversal of the direction of spindle rotation, during machining. Plunger 36 may be advanced and retracted via a second plunger 38, spring 40 and end cap 42 with cam-shaped surface 44. It can be seen that by urging plunger 38 away from backing ring 10 (e.g. in any suitable manner such as hydraulically, pneumatically, electrically or manually), a finger-like protrusion 46 on plunger 36 will ride along cam surface 44 under the force of spring 48 thereby lifting the plunger from its position in groove 28 and uncoupling backing ring 10 and outer ring 6 from clamp ring 8 and spindle 4. In the opposite manner, advancing plunger 38 toward backing ring 10 will force plunger 38 inwardly into one of grooves 28.

Preferably, end cap 42 includes an extended portion 50 (FIG. 4) in receiving bore 34 that ends at or near the inner surface of backing ring 10 whereby movement of plunger 38 (and hence, movement of plunger 36) is effected by movement of plunger 32. Thus, uncoupling of backing ring 10 and outer ring 6 from clamp ring 8 and spindle 4 may occur simultaneously with locking backing ring 10 and outer ring 6 against rotation relative to rotation of spindle 4.

In operation, with clamp ring 8, backing ring 10 and outer ring 6 assembled on spindle 4 as recited above and as shown in FIG. 2, an arbor chuck 2 (shown for illustrative purposes with known types of conventional gripping collet 52 and nose piece 54 which are not part of the present invention) is inserted into outer ring 6, backing ring 10 and outer ring 6 are locked against rotation via plunger 32 being advanced and plunger 36, if present, is retracted from groove 28. Spindle 4 is then rotated by an appropriate amount and in an appropriate direction to engage holding angled lug 18 with holding angle ramp 22 in order to draw arbor chuck 2 into position against spindle 4 (FIG. 4). Plunger 32 is then retracted and plunger 36, if present, is advanced into a groove 28 to lock the backing ring 10 and outer ring 6 to the clamp ring 8 and spindle 4. A workpiece 62, such as a bevel pinion gear, may then be inserted into the arbor chuck 2 wherein the shank of the workpiece is gripped by the collet 52 due to the rearward motion of a draw rod (not shown) releasably attached to lug 64. After machining, the workpiece 62 is released from the arbor chuck 2 by opposite motion of the draw rod and collet 52 and the workpiece loading, machining and releasing sequence is repeated for any additional workpieces.

When it becomes necessary to remove arbor chuck 2 from spindle 4, backing ring 10 and outer ring 6 are locked against rotation via plunger 32 being advanced and plunger 36, if present, is retracted from groove 28. Spindle 4 is then rotated by an appropriate amount and in an appropriate direction (opposite of the engaging procedure discussed above) thereby bringing ejecting angle ramp 24 into engagement with ejecting angle lug 20 to loosen the arbor chuck 2 from the spindle 4 (i.e. tapered shank 26 of the arbor chuck 2 will be loosened from its position against the tapered surface 3 in bore 5 of machine spindle 4). The arbor chuck 2 may then be removed from the machine.

It is to be understood that upon inserting arbor chuck 2 into spindle bore 5, sufficient friction usually exists between tapered surface 26 of the arbor chuck shank and the tapered bore surface 3 whereby arbor chuck 2 will rotate with spindle 4 without slippage in order to engage the holding angle lugs 18 and the holding angle ramps 22. However, a key and keyway arrangement (not shown) may be included at appropriate locations on the arbor chuck and spindle to enhance contact therebetween.

If desired, covers 56, 58 and/or 60 may be included to prevent or reduce contamination of arbor chuck assembly components by machining fluids, metal particles, lapping compound, grinding swarf, etc.

While the present invention has been discussed and illustrated showing a type of arbor chuck that includes a nose piece and a contracting workpiece shank gripping collet, the present invention does not contemplate nor is it to be limited to the inclusion of, or to specific types or designs of, such elements. The manner by which a workpiece is supported, gripped or spatially positioned on the inventive arbor chuck is dependent upon the particular geometry and dimensions of the workpiece being machined as is well understood by the skilled artisan. Therefore, the means by which a workpiece is supported, gripped or spatially positioned on the inventive arbor chuck does not form part of the present invention. For example, an expanding collet may be utilized in the present inventive arbor chuck for gripping ring gears.

While the invention has been described with reference to preferred embodiments it is to be understood that the invention is not limited to the particulars thereof. The present invention is intended to include modifications which would be apparent to those skilled in the art to which the subject matter pertains without deviating from the spirit and scope of the appended claims.

What is claimed is:

1. A workholding apparatus for a machine tool, said workholding apparatus comprising:
an arbor chuck having at least one holding angle lug and at least one ejecting angle lug;
an outer ring having at least one holding angle ramp and at least one ejecting angle ramp;
a clamp ring;
a backing ring;
whereby said arbor chuck is attachable to a spindle of the machine tool by rotational engagement of said at least one holding angle lug with said at least one holding angle ramp, and said arbor chuck is removable from the spindle of the machine tool by rotational engagement of said at least one ejecting angle ramp with said at least one ejecting angle lug.

2. The workholding apparatus of claim 1 wherein said clamp ring is positioned within said backing ring.

3. The workholding apparatus of claim 1 wherein said clamp ring includes a plurality of spaced apart grooves located about an outermost periphery thereof.

4. The workholding apparatus of claim 1 wherein said arbor chuck includes an outer periphery with said at least one holding angle lug and at least one ejecting angle lug being located on said outer periphery.

5. The workholding apparatus of claim 1 wherein said outer ring includes an inner diameter surface with said at least one holding angle ramp and at least one ejecting angle ramp being located on said inner diameter surface.

6. The workholding apparatus of claim 1 further including means for holding said backing ring and said outer ring stationary during rotation of said spindle.

7. The workholding apparatus of claim 6 wherein said means for holding comprises a plunger extendable into a receiving bore in said backing ring.

8. The workholding apparatus of claim 3 further including means extendable from said backing ring into one of said spaced apart grooves on said clamp ring thereby locking said backing ring and said outer ring to said clamp ring.

9. The workholding apparatus of claim 8 wherein said locking is achieved by first and second plungers, said first plunger being movable to effect motion of said second plunger into and out of engagement with said groove.

10. The workholding apparatus of claim 9 further including a plunger extendable into a receiving bore in said backing ring for holding said backing ring and said outer ring stationary during rotation of said spindle, wherein movement of said plunger effects movement of said first plunger whereby uncoupling of said backing ring and said outer ring from said clamp ring and said spindle occurs simultaneously with locking said backing ring and said outer ring against rotation relative to rotation of said spindle.

11. A method of positioning a workholding apparatus on a machine tool, said method comprising,
inserting a clamp ring into a backing ring and attaching said clamp ring to a spindle of said machine tool, said spindle having a spindle bore;
attaching an outer ring to said backing ring, said outer ring including an inner diameter surface with at least one holding angle ramp and at least one ejecting angle ramp being located on said inner diameter surface;
providing an arbor chuck having an outer periphery with at least one holding angle lug and at least one ejecting angle lug being located on said outer periphery, said arbor chuck further including a shank portion;
inserting said arbor chuck through said outer ring and into said spindle whereby said outer periphery of said arbor chuck is positioned within said inner diameter surface of said outer ring and said shank is positioned within said spindle bore;
locking said backing ring and said out ring against rotation;
rotating said spindle in a first direction to engage said at least one holding angle lug with said at a least one holding angle ramp to thereby draw said arbor chuck into position against said spindle.

12. The method of claim 11 further including unlocking said backing ring and said out ring against rotation.

13. The method of claim 12 further including rotationally locking said backing ring and said outer ring to said clamp ring and said spindle whereby rotation of said backing ring and said outer ring relative to rotation of said spindle during a machining process is prevented.

14. The method of claim 12 further comprising removing the positioned arbor chuck from said spindle, said removing comprising:
locking said backing ring and said out ring against rotation;
rotating said spindle in a direction opposite to said first direction to engage said at least one ejecting angle ramp with said at least one ejecting angle lug to thereby loosen said arbor chuck from said spindle; and
removing said arbor chuck from said spindle.
